(19) United States
(12) Patent Application Publication
(10) Pub. No.: US 2003/0046338 A1
(43) Pub. Date: Mar. 6, 2003

(54) System and method for using programable autonomous network objects to store and deliver content to globally distributed groups of transient users

(76) Inventor: Walter H. Runkis, Monroe, CT (US)

Correspondence Address: Walter H. Runkis, 78 Lantern Drive, Monroe, CT, 06468, US

(21) Appl. No.: 09/946,064

(22) Filed: Sep. 4, 2001

(51) Int. Cl. G06F 15/16

(52) U.S. Cl. 709/203

(57) ABSTRACT

The present invention relates to a system and method which employs a globally distributed computer network populated by a plurality of programmable autonomous network objects (“PANOs”) to facilitate the storage and delivery of digital information, and services based thereon, to a plurality of globally distributed groups of transient users. In a broader embodiment, the invention provides software that behaves substantially in the manner of a superobject, that causes hardware to behave in a substantially autonomous manner.

### PRIOR DISCLOSURES

This application hereby incorporates by reference disclosures previously filed as Disclosure Document No. 492416, Apr. 16, 2001, entitled “Business Model For Distribution Of Content Via A Mobilized Global Computer Network,” and Disclosure Document No. 495136, Jun. 11, 2001, entitled “System And Apparatus For Using Mobile Network Objects To Store And Deliver Content To Transient Users.”

### BACKGROUND OF THE INVENTION

Need for the Present Invention

There is a long felt need to create a global virtual computing environment that has the capacity to deliver entertainment and educational content, and business and e-commerce transaction services to vacationers and business travelers (herein referred to as “transient users”). In short, the present invention is drawn to a system and method that provides at least substantially all of the services available to users through their home-based personal computer or business based personal-computer no matter where they may be.

The computing needs of transient users differ in several important aspects from the computing needs of “resident users.” However, current network and business models designed to deliver content and business services to transient users are largely based upon the same “video streaming” and Internet data distribution concepts that are commonly practiced on the Internet for providing multimedia information services to resident users. Furthermore, except for a few “online” services designed to permit transient users to connect their personal laptop and hand-held computers to the Internet, the overall computing needs of transient users are largely ignored altogether.

Evolution of Online Delivery of Multimedia Services

Prevailing network and streaming models designed to deliver multimedia “content” to resident users over a wide area network (hereinafter referred to a “WAN”), such as the Internet, owe their origins to standard “broadcast” models which are commonly practiced by radio and TV broadcasting entities. Standard broadcast models are also referred to as “multicast” models, which may further be referred to as “point-to-multipoint.” The major drawbacks to multicasting are:

a) content must be prescheduled and simultaneously broadcast to a multitude of users, so true video-on-demand (hereinafter referred to as “VOD”), where users can select and view whatever content they want whenever they choose to view it, is not possible;

b) pay-per-view (herein after referred to as “PPV”) is possible using multicast methods. However, advertisements inserted into video streams cannot be “targeted” to individual viewers. This limitation increases a viewer's sense of intrusiveness due to the generalized nature of advertisements, and substantially lessens the impact of such advertisements.

The capacity of microcomputers for storing demographic and psychographic profiles for a multitude of individual “users,” i.e. “viewers,” has given birth to a need to provide unicast streaming services which can be monetized by inserting targeted advertisements into “bit streams.” Targeted advertising has been demonstrated to be substantially more powerful in its appeal to viewers than traditional broadcast advertising. This is true because it allows each advertisement to be specifically tailored to each individual user according to each individual user's unique demographic and/or psychographic profile. Furthermore, by using unicast methods to facilitate content delivery, the transmission of content does not have to be pre-scheduled. Users can watch whatever they want to watch whenever they want to watch it. For these reasons and others, unicast is the preferred choice for delivery of VOD and PPV applications.

Current technologies aimed at delivering VOD and PPV content to consumers are primarily focused on providing services that meet the needs of resident users. Broadband transmission bit rates, i.e. transmission bit rates commonly considered to be equal to or greater than 200 kilobits per second (hereinafter referred to as “Kbps”), are routinely delivered to homes and offices via digital subscriber links (hereinafter referred to as “DSL”) over cable television lines and standard telephone lines. DSL services are available today in most major cities, and service providers are steadily “wiring” the outlying countryside as well. Satellite services, such as Hughes' Direct PC™ and others, also provide wireless broadband services to resident users at maximum bit rates of up to about 400 Kbps.

As prevalent as DSL services are becoming, most existing services are still inadequate to unicast full-screen episodic content to viewers at a quality that is equal to or greater than the National Television Standards Code (herein after referred to as “NTSC”) broadcast television quality to which viewers are presently accustomed. Most standard DSL services have only three bandwidth services to choose from: 275 Kbps, 512 Kbps, and 768 Kbps. And furthermore, it must not be overlooked that the bandwidths purportedly offered by DSL services are nominal bandwidths. The actual bandwidth available to a subscriber at any given time may be substantially reduced by the amount of network activity then present. In order to reliably unicast content at qualities equal to or greater than NTSC quality, actual bandwidth must exceed 800 Kbps, and preferably be equal to or greater than about 1,200 Kbps. Largely for this reason, several ventures designed to deliver VOD to resident users have failed in the “last mile.”

Need for the Present Invention by Transient Users

There is also a growing awareness today of the need to provide VOD, PPV, and broadband Internet services to transient users. Unfortunately, emerging solutions aimed at addressing this need are not unique. Instead, they are largely adaptations of solutions currently being practiced to deliver digital information to resident users. The needs of transient users differ from those of resident users in several important respects. Among others, the major differences are:

a) travelers are generally away from their accustomed computing environments;

b) most travelers do not carry portable computers with them, and many of those that do would not if an alternative were devised to free them from the necessity;

c) batteries that power laptop computers do not generally store enough energy to power laptop computers during the entire duration of many trips.

d) travelers spend considerable, and otherwise non-productive, time waiting in airplanes, airports, hotels and other areas where access to computers and computer networks is generally unavailable; and,

e) since airplanes, and the like, run on rigid time schedules, watching complete presentations of scheduled real-time episodic content such that which is available on satellite TV is often impossible.

The need for inflight multimedia services has spawned the creation of systems like those offered through iPass™, Inter-Touch™ and Connexion by Boeing™. These services provide transient users with the means of connecting to the Internet from certain aircraft or from certain terrestrial locations.

However, this is the case only if the transient user has a laptop or other personal computing equipment at his disposal. iPass and Connexion also offer airline passengers inflight television programming received from satellite television transponders. Travelers often complain that content selections are limited to only those mostly uninteresting programs then available on the satellite and the TV screens by which to view such programming are too small. Some airlines also offer up to 16 VOD movie choices, wherein content is transferred from a central storage device onboard the aircraft to each passenger using “store and forward methods” with individual hard drives located under each passenger's seat. This system has proven to be problematic, however, due to the high failure rate caused by frequent hard drive crashes. This is a predictable problem since hard drives are notoriously vulnerable to strong vibrations such as landing shock.

Inherent Limitations of Current Inflight Multimedia Delivery Models

Connexion by Boeing and iPass are services aimed at providing inflight satellite television services. They also provide a range of Internet services to airborne passengers, such as World Wide Web browsing, and email delivery and transmission. Unfortunately, Connexion and iPass are costly and are likely to remain so due to the inherent technological complexity of providing such services to transient users via satellite.

Also proposed as future services by iPass, Connexion by Boeing and others is real-time video streaming of episodic content files stored on terrestrial databases. The content files must be first transmitted to an earth-orbiting satellite, and then retransmitted to the aircraft. Such future services, on a commercial scale, are not currently possible due to bandwidth limitations imposed by the present state of development of the telecommunications technology currently available to facilitate the future services. Moreover, even when real-time streaming and satellite delivery of episodic content stored on terrestrial databases does become possible, the future services are still likely to be costly and inefficient since they are based upon the same broadband Internet video streaming methods that are provided to only a few resident users today.

Proposed video streaming models envision transmitting VOD content to from 100 to 600 or more transient users at some date in the future. To provide the VOD content, each transient user's content selection must be transmitted from the terrestrial database to an earth-orbiting telecommunications satellite and then retransmitted from the satellite to the aircraft in real time. For this to be of practical value, transmission bit rates must be high enough to facilitate viewing the selected content in real time. This means each transient user must be provided with greater than 800 Kbps of actual bandwidth and preferable the actual bandwidth provided should be about 1 Mbps or greater.

Of course, streaming video files could be transmitted to transient users from terrestrial databases using “store-and-forward methods.” This is providing transient users are willing to wait for the entire content file to be transmitted to the aircraft and stored on nonvolatile storage media before it can be streamed to the passenger's display device. Though possible, the store-and-forward option is clearly impractical. Even at the full bandwidth of common DSL (about 1.5 Mbps) it would take about 48 minutes to transfer an average 90 minute movie encoded at a bit rate of 800 Kbps.

The major impediment to real-time wireless delivery of multimedia content to globally distributed groups of transient users is the vast quantity of bandwidth required for the transmission of such content. Presently, the delivery of digital Internet services to airline passengers is performed in a manner similar to that of using a dialup telephone connection to connect a terrestrial-based computer to the Internet. Using Connexion by Boeing as a model, the current connectivity available to serve the needs of all passengers for inflight Internet services and other online digital multimedia services is reportedly only 128 Kbps per aircraft. This is adequate to transmit interspersed packets of HTML data between a few of the airplane's passengers and the Internet, but it is woefully inadequate if the goal is to stream full-screen NTSC-quality episodic content on demand, i.e. VOD, to even a single passenger.

VOD requires unicast streaming for delivery, wherein a single bit stream is transmitted from a single server to a single viewer, i.e. “point-to-point streaming.” Unicast streaming of multimedia content files in real time consumes substantial bandwidth. For example, a plane carrying 300 passengers, watching full-screen 90-minute movies, encoded at minimum NTSC quality using an MPEG-2 codec with an encoded bit rate of 800 Kbps would consume over 1.25 trillion bits of information. The “pipe” into the aircraft would have to be as large as about 1½ OC-3 fiber optic cables. And it must be empathized that this amount of bandwidth only serves the consumer demand that would be generated during a single flight. The Federal Aeronautics Administration (hereinafter referred to as the “FAA”) reports that only ten of the total number of US domestic airlines reported over 500 million domestic passenger flights during 1999. The Travel Industry Association of America reported 1.01 billion domestic flights of 20 minutes or greater duration in 1999. Worldwide, the total number of annual flights is estimated to exceed 3 billion flights per year.

To put this need for bandwidth into perspective, a single typewritten page holds about 1,000 five-character words, which is about 40,000 bits of digital information. Therefore, a single plane carrying 300 passengers watching feature movies would fill a book of well over 31 million pages in an hour-and-a-half. Moreover, even if such bandwidth were available, it would be especially wasteful, as well as costly, to consume it in such a manner since it is probable that many passengers would be predisposed to watching only a small group of “new releases.” It is also probable that many passengers would be viewing the same presentation, but not at the same starting times. Therefore, even though the many passengers might be watching the same movie, doing so on a VOD-basis with each of the many passengers starting the movie whenever they chose would require unicast presentation of the individual movie bit streams.

Providing unicast streaming of multimedia content to billions of airline passengers will consume massive WAN-bandwidth. Using earth-orbiting satellites to transmit such a vast quantity of multimedia data simply isn't possible using current telecommunications technology and video streaming models. Moreover, even when it does become possible to do so at some distant future date, it is highly probable that the cost of consuming so vast a quantity of WAN-bandwidth will be prohibitive given the alternative offered by the present invention. By practicing the present invention to offer unicast inflight multimedia services to airline passengers, the dependence upon using WAN-transmitted bandwidth to deliver the inflight multimedia services could be reduced to practically zero.

Solutions Provided by the Present Invention

The most fundamental embodiment of the present invention teaches a novel system, method and apparatus that solves several problems which are currently impeding attempts to offer entertainment, business and e-commerce transaction services to globally separated groups of transient users. By providing these services to transient users according to the practice of the present invention, the reliance upon WAN-transmitted bandwidth for delivery of the services is substantially reduced. This is especially true for repetitive services such as viewing entertainment and/or educational episodic content.

A more complex embodiment of the present invention teaches a system, method and apparatus that provides an extension of a user's home and/or office computing system, apparatus and environment for transient users. By practicing the present invention, transient users are no longer required to carry laptop computers with them in order to experience the benefits of a home and/or office computing system, apparatus and environment. It is a prime objective of the present invention to provide a substantially uninterrupted computing environment that appears to virtually travel with transient users wherever the present invention is practiced. In this manner, the need to carry laptop computers is substantially reduced or may be eliminated altogether.

### REFERENCES TO PRIOR ART

The present invention differs in several important aspect from systems and methods taught by prior art.

U.S. Pat. No. 5,809,299 which is a continuation in part of U.S. Pat. No. 5,555,407 teaches a multimedia system for providing electronic information and transaction services. It combines shared remote access to a utility database with local access to a local database. When information access is requested from an interactive multimedia player provided with the local database and coupled through a telecommunication network to the utility database, the information is first searched in the local database.

U.S. Pat. No. 5,999,934 teaches a distributed database system that includes a central station for accumulating and distributing data on a database. The patent further teaches a plurality of receiver stations that receive the data and selectively make at least portions of the data available in accordance with the demands of a user. A transmitter encodes and transmits the sequential data stream for delivery embedded within television signals.

Additionally, U.S. Pat. Nos. 5,963,948; 5,937,163; 5,926,624; 5,905,865; 5,873,088; 5,870,765; 5,848,373; 5,841,980; 5,758,355; 5,754,787; 5,727,129; 5,710,884; 5,689,708; 5,586,257; 5,577,208; 5,404,505; 5,317,568; 5,283,638 and 5,247,615 teach various computer network systems. U.S. Pat. Nos. 6,038,545; 6,209,787; 6,195,694; 6,078,848; 5,237,157; 5,953,725; 5,949,411; 5,734,719; 5,761,071 and 5,758,257 disclose various species of kiosk designs. U.S. Pat. Nos. 6,199,099; 6,154,745 and 5,519,706 disclose wireless and mobile computing systems. U.S. Pat. Nos. 6,112,181; 6,088,722; 5,956,716; 5,795,288 and 5,617,539 all show multimedia systems.

### BRIEF DESCRIPTION OF DRAWINGS

FIG. 1 is a schematic diagram illustrating the basic hardware components required to create a Programmable Autonomous Network Object (“PANO”) in accordance with the present invention.

FIG. 2 is a schematic diagram illustrating the structural overview of a digital multimedia storage and delivery network populated by a globally distributed plurality of PANOs for providing electronic services to isolated groups of transient users in accordance with the present invention.

### SUMMARY OF THE INVENTION

The present invention relates to a system, method and apparatus that provides a platform which economically facilitates the provision of at least substantially the same services that transient users would otherwise have available to them through their own PC's (“personal computers”) within their homes and/or their business computers within their places of business. These services include, but are not limited to:

a) the capacity to store and deliver electronic information such as audio and/or video entertainment and educational content;

b) the capacity to run interactive games;

c) the capacity to run business software applications;

d) the capacity to transact e-commerce marketing activities; and,

e) the capacity to interactively link to a WAN such as the Internet for real-time 2-way transfer of digital information, and the like.

Items “a” through “e” listed above are hereinafter referred to collectively as “services.” Therefore, a primary object of the present invention is to deliver the services to globally distributed groups of transient users.

The basic platform unit of the present invention is an appliance referred to herein as the programmable autonomous network object (hereinafter referred to as a “PANO”). The PANO provides a nexus between individuals who are temporarily grouped into spatially and temporally isolated populations of transient users. Each PANO is comprised of a group of computer-related hardware and software components. Each PANO is sufficient to provide a wide variety of services to a plurality of globally distributed populations of transient users, e.g. vacationers, business travelers, and the like.

The present invention uses PANOs to create local “service zones” wherein individual entertainment, information, and computing environments appear to travel with the individual transient user. In accordance with a preferred embodiment of the invention, PANOs are provided on mobile platforms, such as those located onboard landcraft, automobiles, taxis, limousines, buses, trains, spacecraft, space stations, aircraft, watercraft, boats, ocean-going vessels, e.g. cruise ships, aircraft carriers and submarines, and the like. In another preferred embodiment of the invention, PANOs are provided on stationary platforms, such as those located in spaceports, airports, seaports, landcraft bases, seacraft bases, aircraft bases, spacecraft bases, hotels and resorts, and the like. Typically, PANOs will be provided anywhere a concentration of transient users might congregate from time to time in populations of sufficient size to warrant an investment in the equipment and infrastructure necessary to practice the invention. It is an object of the present invention to provide a globally distributed network of PANOs at moving or stationary points of itineraries. The PANOs at these points will enable groups of transient users to seamlessly access “redundant collections of multimedia information,” as well as applications software and user-specific data files. In this respect, the invention is analogous to a system, method and apparatus such as that provided to a mobile telephone caller who moves between individual cell phone zones having no awareness of exiting one zone before entering another.

The Programmable Autonomous Network Object

As noted above, the basic functional unit of the present invention is the programmable autonomous network object, i.e. PANO. A PANO is comprised of redundant collections of multimedia information which are stored and delivered to a population of transient users by means of a grouping of components. These components include, but not limited to: hardware devices, various programmable automation utilities, device drivers, software applications, and data sets. All of the components are presided over by an object oriented program referred to herein as the “superobject.” The superobject is a central control program or expert system that encapsulates and integrates the functionalities of all the PANO's hardware, software and digital information components. This is done in such a manner as to make the entire PANO function as a unified self-sufficient entity. The superobject monitors and controls all functionality within itself. It provides machine to machine interfaces. It also provides machine to human interfaces for communicating with the population of transient users and the world around it. The PANO communicates with the world around it by sending and receiving messages.

To gain a comprehensive understanding of the PANO and its manifold operations and hence an understanding of the present invention, it is necessary to review the evolution of machine automation programming constructs and logic, as such are implemented in microcomputers.

Linear Programming Techniques

The earliest and simplest computer programming constructs were all top down systems written in binary or assembly language. That is to say, when a computer called a program into memory, it would begin executing one instruction at a time, starting at the top of a list of separate instructions, and would continue by executing one instruction at a time until the program terminated when it reached the bottom. The exception to this appeared with the “jump” (jmp) command, which allowed programmers to designate a block of code as a subroutine, that could be executed every time program flow was redirected to the subroutine's starting address.

Eventually, Beginner's All-purpose Symbolic Instruction Code (hereinafter referred to a “BASIC”) was ported over from mainframe computers to microcomputers. BASIC introduced several important language constructs. These included variables, arrays, loops, subroutines and user-defined functions, among others. These features provided programmers with greater functionality. However, BASIC was still inherently “clumsy” as a means of building large-scale software applications. One of the reasons for this was that variables in BASIC were globally scoped, i.e. they were visible everywhere within the program and therefore easily corrupted.

With the release of UCSD Pascal, microcomputer programmers were provided with the capacity to develop more elegant programs. In Pascal, globally scoped subroutines were replaced by locally scoped functions and procedures. And the awkward line numbers that plagued programmers in BASIC applications were eliminated altogether.

Later came the “C” language, invented by Brian W. Kernighan and Dennis M. Ritchie of Bell Labs. As a programming language, C shared a few similarities with Pascal but was much more robust. Values were “typed” and stored in locally scoped variables. Programs were tightly structured by defining and calling functions. Program flow was controlled by using loops, “if statements” and “function calls.” Input and output could be directed to the terminal, to a printer, or to files. Related data could be grouped and stored in arrays and structures. Of all the languages available to early programmers, C allowed by far the most precise control over input and output operations which made it ideal for programming real-time telemetry and control applications, computer-controlled automation processes, and expert systems.

C was also more terse than BASIC and Pascal. When programmers made wise use of C's range of powerful operators, they are able to write programs that were fast, compact and efficient. Unfortunately, it also allowed a sloppy programmer to produce code that was unintelligible to anyone but the person who wrote it. C also made extensive use of “pointers” (“indirect addressing” is the more technical term). Programmers who were skilled in manipulating pointers could write tight compact code that used fewer microprocessor clock cycles. Consequently this code executed faster than code written to perform similar behaviors in other languages.

The first implementation of the C language was a native form of UNIX. This became known as “Bell Labs C” after the most popular compiler, or “K&R C,” after its inventors. This implementation is also be referred to as “Classic C”.

The UNIX operating system was written in C. In fact C was invented specifically to implement UNIX. All of the UNIX commands, which programmers entered at the keyboard (or the like), plus system utilities such as password checking, line-printer queues, and magnetic tape drivers were all written in C. Moreover, in the course of the developing UNIX, hundreds of functions were written that gave access to various facets of the operating system. These functions were made available to programmers in the form of libraries. By writing in C, and using these UNIX system libraries, very powerful programs could be created using a minimum amount of code. Since these system libraries were difficult (and often impossible) to access using other programming languages, C became the default language for writing UNIX system programs.

It did not take long for C to take the world of microcomputer programming by storm after it was ported over for use by microcomputer programmers, just as it had in the world of mini's and mainframes. Commercial versions of C came with libraries of standard functions. Moreover, programmers could purchase additional specialty function libraries that made it a straightforward process for programmers of average skill to manipulate every aspect of microcomputer functionality, such as providing direct access to serial ports, peripherals, device drivers, and memory. Programming logic construction had come a long way. Because of that, software applications were getting larger and more complex. However, despite these advancements, programs were still written primarily as linear, top-down constructs.

Object Oriented Programming (“OOP”)

A large-scale software application is essentially a collection of functions, or subroutines, that perform specialized repetitive tasks within the confines of the overall application. For example, a telecommunications program may use a function, called “InitModem( ),” to transmit a string of initialization code to a modem card installed on the computer's internal buss. These lines of code, sometimes referred to as “logic” or “instructions,” provide a stepwise series of commands that activate the internal circuitry of the modem making it ready to transfer information between itself and another modem. A second function, called “DialPhone( ),” may activate the phone line, wait to detect a dial-tone, and then transmit a sequence of tones which dials the telephone number of a remote computer. A third function, called “ShakeHands( ),” might transmit and receive strings of data, called handshaking, to and from the remote computer. In this manner, the two machines are synchronized. Other functions would also be created to perform every task needed by the application to accomplish its telecommunications mission. Such functions are generally written to be reused, over and over again, in any desired order. This practice is commonly referred to as writing reusable code. As the size and complexity of software applications continued to grow, writing reusable code became utterly essential to the process of writing, debugging and maintaining large-scale applications.

Our dependence upon computers increases daily. Advances in information technology offer perhaps our only hope of maintaining order in a technological world that is becoming more complex by the minute due to the sheer volume of information that is currently available. The language constructs of Object Oriented Programming (hereinafter referred to as “OOP”) were invented to advance this need. There are now several languages based upon OOP principals. These include C++, a superset of C, and Java, among others. Today, most computer software, e.g. large-scale business applications, and machine automation and control applications, are written in C++. Increasingly more Internet applications and applets are written in Java.

As previously noted, the PANO is a fundamental apparatus element required for the practice of the present invention. The principals of OOP, as implemented in C++, are of particular relevance to the present invention since the PANO behaves in a logical manner much the way an object might logically behave in C++.

An object in C++ is a software construct that bundles and “encapsulates” a group of related “methods” and “properties.” In C++, methods are algorithms that work much like functions in a Classic C program. They perform a specific action, or small group of actions, when called. Likewise, properties act like variables. They serve as pigeon holes to store many disparate types of data within the object. Encapsulation is the mechanism used by C++ to implement data abstraction or “information hiding.” It is the technique that an object employs to package and sequester data within itself, together with the operations that act upon the data. In this manner such data can only be manipulated by means of an object's internal operations. It is encapsulation that protects data from corruption and makes a well-constructed object behave autonomously.

Software objects have commonly been used to model real-world objects found in everyday life. The major difference between an object in C++ and a PANO is the PANO is an object comprising collections of both hardware and software that are logically encapsulated by its “superobject.” The superobject is an object oriented software application that presides over all the various components of hardware, software and data elements of which the PANO is comprised. The superobject monitors, controls and regulates every aspect of the PANO's behavior and functionality, including all of the functionalities of the plurality of objects contained within itself, physical as well as logical. Therefore, it is not considered a unique feature of the present invention that a PANO functions as any one of a: a) localized closed-loop Point of Presence (hereinafter referred to as “POP”); b) local area network; c) digital information archive; d) home/office computing system; e) home entertainment center; f) interactive computer gamming device; g) Internet access gateway; or h) an e-commerce transaction provider. One of the things about the present invention that is unique, is that it utilizes a globally distributed network of PANOs to function like specialized robots. These specialized robots perform all the manifold functionalities described in items “a” through “h”, listed above. They perform these functionalities in a self-sufficient manner and require substantially no human interaction to operate after the PANO is built, programmed and placed into service.

Each of items “a” through “h,” as such are commonly practiced for the benefit of resident computer users, require a multitude of informed human interactions to initiate and maintain normal functionality. Informed human interactions are commonly required to perform the myriad of operational tasks needed by the various units of machinery and software. Furthermore, informed human interactions are necessary in order to operate and maintain the plurality of software applications, data sets, and machine control factors relative to the multitude of separate and disparate operations being performed by the various units of machinery and software.

A PANO, under the control of its superobject requires a minimum of informed human interactions to function normally. The PANO makes it possible, practical, and cost-effective to deliver all the functionalities described in items “a” through “h,” to globally distributed groups of transient users located in hard to access remote locations. These locations include locations such as: an airplane flying at an altitude of 35,000 feet, or a ship at sea.

Services Facilitated by Practicing the Present Invention

The present invention is practiced in such a manner so as to provide globally separated groups of transient users with a globally distributed network of PANOs that all function as uniformly consistent but distinct “service zones.” The central controller of the invention integrates and synchronizes its plurality of PANOs. This is done by means of transmitting messages over a globally distributed communications network, i.e. wide area network (“WAN”). The globally distributed communications network can be a public WAN, such as the Internet, or a private WAN, such as an ATM feeder network.

All the service zones facilitate storage of and access to redundant collections of multimedia information. All PANOs provide the service zones in such a manner that transient users moving from one PANO to another are generally unaware of changes in their digital environment. This means that from the perspective of their virtual computing environment they are not aware of when they have exited one service zone and entered another. An integrated globally distributed network populated by PANOs makes it possible for all transient users traveling through such a network to have access to essentially the same collections of digital information in each and every service zone they traverse. This is because all such collections of digital information are redundantly stored in every PANO. The only files that are not redundantly stored across all PANOs are transient users' environmental preference codes and user-generated data files which are created by, or on behalf of, transient users. The transient user's environmental preference codes and user-generated files are forwarded from PANO to PANO, or from the central controller to a PANO, in such a manner that the environmental preference codes and user-generated data files appear to travel with the transient user.

Each PANO has a quantity of nonvolatile storage (referred to hereinafter as the “free store”) for storage of user-generated data files and user environment preference codes. By practicing the present invention the user-generated data files and user environment preference codes are automatically transmitted from the central controller and/or from PANO to PANO according to:

a) using a software utility especially written for such purpose, a transient user generates a predefined set of instructions containing the transient user's travel itinerary and accompanying user-generated data files. The software utility causes the transient user's travel itinerary and accompanying user-generated data files to be transmitted to the central controller. The central controller receives the transient user's travel itinerary and user-generated data files and safely stores them in the central controller's database on a nonvolatile storage medium. Based upon the transient user's travel itinerary, the central controller then automatically retransmits the travel itinerary and accompanying user-generated data files, together with the transient user's environment preference codes, at times which are appropriate to be received by all PANOs that are scheduled to be temporary destination points along the path of the user's itinerary;

b) a real-time request submitted by the transient user, from a PANO occupied by the transient user, to the central controller designating one or more user-generated data files to be immediately transferred in real-time from the central controller's database to the PANO then occupied by the transient user. Upon receiving the request, the central controller would transmit such user-generated data files as may be stored in its database, along with the transient user's environment preference codes to the requesting PANO;

c) a real-time request submitted by an agent or representative of the transient user designating one or more user-generated data files to be immediately transferred in real-time from the home or office computer of the transient user to the PANO then occupied by the transient user. The central controller would receive the real-time request, including the one or more user-generated data files, and immediately forward them, together with the transient user's environment preference codes to the PANO then occupied by the transient user.

d) user-generated data files may also be transmitted by an agent or representative of the transient user to the PANO then occupied by the transient user in real time as one or more email attachments.

The network design taught by the present invention has multiple advantages over network designs taught by prior art in regard to meeting the unique computing needs of transient users. Some of the more obvious advantages unique to the present invention are:

a) since the present invention provides every transient user with an “access portal,” all transient users have access to all the digital information and services that are available in every service zone along the transient user's itinerary without the need to carry a personal computing device with them;

b) a transient user can start watching a feature movie in one service zone, e.g. on a flight from New York to Chicago, pause the movie when the plane arrives at the airport in Chicago, change planes, and continue watching the same movie, from the point that at which it was interrupted, on a different plane or even a different airline during the continuing flight, e.g. to San Francisco;

c) a transient user could instruct the present invention to store one or more personal data files, such as an unfinished business plan, on the network's central database. The invention would automatically send copies of the files to every destination along an itinerary of destinations at the appropriate times and in such a manner so as to make the one or more personal data files available to the transient user as the files are needed;

d) a transient user can write a letter or continue working on an unfinished business plan in one service zone, e.g. on a flight from New York to Chicago; save the unfinished business plan when the plane arrives at the airport in Chicago; change planes in Chicago; and, continue writing the letter or the unfinished business plan on a different plane and/or different airline during the continuing flight, e.g. to San Francisco. The transient user can save the letter or the unfinished business plan when the plane lands and continue working on such when the transient user checks into a hotel that is also equipped with a PANO;

(e) practicing the present invention conserves WAN-transmitted bandwidth since each data file, e.g. a feature movie, that is stored in the redundant collections of multimedia information is transmitted to each PANO only once. Thereafter, it can be streamed to a multitude of transient users within the closed-loop data processing system of the PANO hundreds or perhaps thousands of times without using additional WAN-bandwidth. WAN-bandwidth is costly. By comparison, bandwidth used within the closed-loop data processing system of a PANO is substantially free.

For these reasons, and others, the network design of the present invention is ideal for the purpose of providing the unique computing and digital information services needed by transient users.

Practice of the Main Embodiment

The present invention is comprised of at least the following parts:

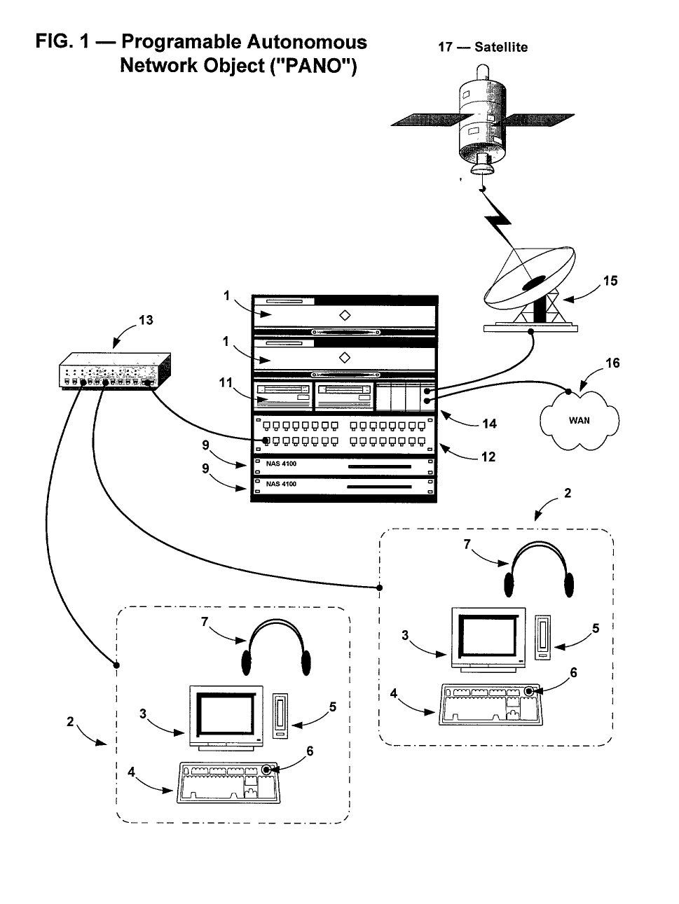

a) a plurality of globally distributed PANOs (FIG. 1.);

b) a central controller and database;

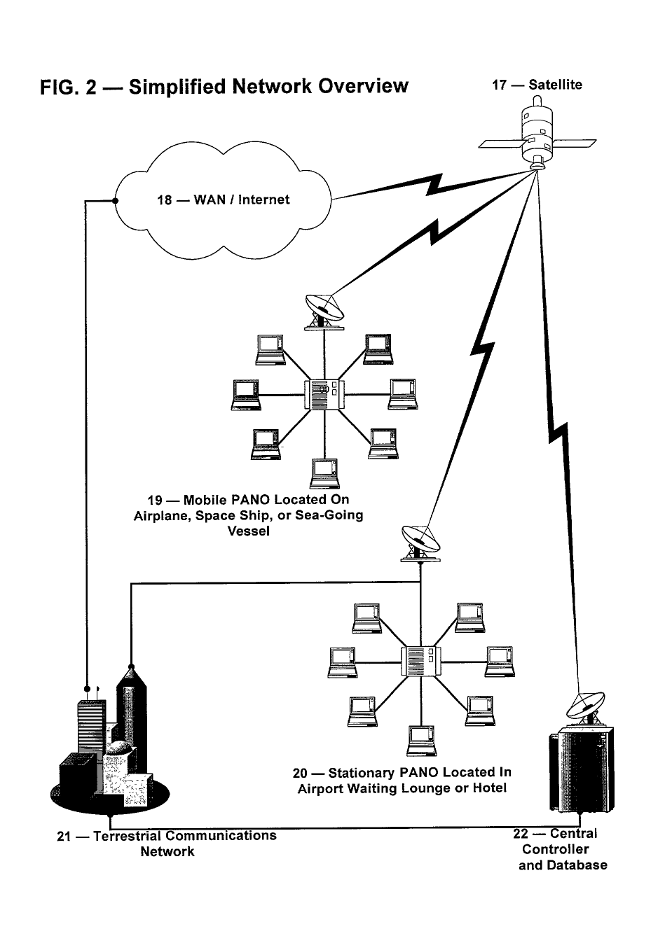

c) a WAN to connect the plurality of globally distributed PANOs with the central controller and database (FIG. 2); and,

d) a unique set of services that require the combined operations of items “a” through “c” to support the manifold functionalities of the services.

Practicing the PANO

Reference is made to FIG. 1 which shows the diagram of a closed-loop data processing system, i.e. PANO. The PANO is an automated, potentially mobile, substantially self-sufficient multimedia storage and delivery system for providing services to globally distributed groups of transient users according to the present invention. Each PANO includes, but is not limited to:

a) a computer acting as a network server or thin client server (1);

b) a workstation (2), i.e. access portal, that serves as a network client or thin client comprising a: monitor (3), keyboard (or the like) (4), card reader device (or the like) (5), cursor pointing device (or the like) (6), and audio headset (7);

c) a mass storage device for nonvolatile storage of digital information, including, but not limited to, a hard drive (8), a redundant array of inexpensive drives (hereinafter referred to as “RAID”) (9), a storage area network (hereinafter referred to as “SAN”), a florescent multilayer disk (hereinafter referred to as “FMD”) (11), and/or such other mass storage system(s) as appropriate;

d) a network router (12) and one or more network switches or network hubs (13) to direct packetized digital information between the network server (1) and the network clients (2); and,

e) a WAN gateway (14) connected to a transmission device, such as a 2-way antenna and/or a satellite dish (15), a fiber optic cable such as an OC-3, or a “copper” cable such as a T-1, DS-3 or DSL (16), and/or any such other transmission device(s) as is necessary to convey digital information over a 2-way communications circuit.

Items “a” through “e,” listed above, are hereinafter referred to collectively as the “hardware.”

Each PANO is presided over by a master control system referred to herein as the superobject. The superobject is an object oriented software program or expert system which is constructed so that each PANO operates in a substantially autonomous manner under the control of its superobject. The superobject has the capacity of causing the sending and receiving of messages, such as commands and arguments, among others. This is analogous to the manner in which an object receives messages in C++. Each PANO is comprised of algorithms called “methods” that initiate and/or control its physical behavior, and “properties” that define or redefine its control parameters, its operating conditions, and/or defines or redefines the scope of its operations. The superobject is responsible for sending and receiving messages between itself and the global network's central controller. It is also responsible for sending and receiving messages between itself and the superobjects of other PANOs. These messages are used to synchronize and coordinate the operations of all PANOs in a globally distributed network populated by a plurality of PANOs. The superobject, together with its methods and properties, including any related data, utilities, buffers and other items of digital information, such as the redundant collections of multimedia information and the user-generated data files, as are required by the PANO to perform its manifold functionalities and related services are herein referred to collectively as the “programming.”

As previously stated, the superobject is an object oriented automation program that presides over all of the manifold functionalities of the various components, both physical and logical, that comprise the PANO. The superobject is capable of constructing messages and sending them to the central controller and other PANOs. The purpose of this function is to control and synchronize the activities of one or more PANOs in a globally distributed plurality of PANOs. The superobject is intelligent enough to make decisions regarding its potential behaviors based upon a set of predefined rules that are redundantly stored in every PANO. As such, the superobject shares in the attributes of an expert system. Specific references to code that comprise the superobject are not relevant to the disclosure of the present invention, since the invention lies in how the superobject works, not in the specific language of the program itself. Given the instant objective e.g., “ . . . causing . . . a close-loop data processing system to behave in a substantially autonomous manner,” one reasonably skilled in the art of computer automation and control programming could write a myriad of programs to effect this unobvious goal.

Each PANO contains at least one nonvolatile mass storage device. This device is logically divided into at least three areas of storage: 1) the programming; 2) a multitude of various types of digital data files, including the redundant collections of multimedia information, and software applications to be used by and/or delivered to transient users; and, 3) a free storage area to hold user-specific environmental parameters, user-generated data files, and such utilities and buffers as might be used by and/or delivered to transient users.

In accordance with the present invention, the construction of the superobjects insures that all PANOs, whether stationary or mobile, are operationally similar to all other PANOs. This does not mean that each and every PANO must comprise exactly the same hardware and programming. It allows that some components comprising the hardware and programming of an individual PANO may vary from appliance to appliance, but the interface presented by each PANO, i.e. its methods and properties, provide a uniform functionality from one appliance to another. Therefore, when operated upon by an outside monitoring and control system, i.e. the central controller, every PANO will exhibit predictably similar behaviors. As a result, the central controller can act upon an individual PANO; one PANO can act upon another PANO; or, all PANOs can be acted upon in unison by issuing a single global method call, i.e. message. This can also be accomplished by passing a single global argument in a method call or to a property. Furthermore, a PANOs may also be acted upon by a software agent which conveys the message containing a method call or argument, to the PANO.

Each PANO may also contain software programs, methods and/or algorithms designed to perform specialized functions for the benefit of the transient user; or for the benefit of the network; or, for the benefit of both. The specialized functions include, but are not limited to:

a) a means for providing a transient user with a high resolution, high fidelity audio and/or video presentation system;

b) a means of managing the digital rights of content owners which may include providing a physical security for hardware, data encryption/decryption schemes, content usage tracking, and various auditing and reporting functions, and the like;

c) a means of tracking a transient user's movements and responses within his/her computing environment for the purpose of developing, refining and maintaining a psychographic profile of the transient user. Tracking the transient user's movements and responses, includes but is not limited to observing the transient user's content selections, click-throughs, and/or e-commerce transactions, as well as evaluating answers to specific queries designed to develop, refine and maintain the transient user's psychographic profile. It is also an object of the present invention that the tracking of the transient user's movements and responses can be disabled by the transient user at any time upon the request of the transient user;

d) a means of facilitating the transaction of e-commerce activities including but not limited to inserting advertising messages into content bit streams, presenting catalogs and catalog selections, providing suitability information regarding products and services, collecting and transmitting direct marketing order information, and the like;

e) a means of collecting and quantifying accounting transaction information for the purpose of tracking and billing those amounts accrued by transient users for services rendered on behalf of, and/or for e-commerce purchases made by, transient users. Additionally, billing and tracking algorithms are used to record the quantity and duration of advertising impressions presented to the transient user.

There may also be exceptions that make it necessary and/or desirable to provide certain PANOs with special methods and/or properties that give them special capabilities not required by all PANOs. For example, it may be beneficial for mobile PANOs located onboard airplanes to contain a ground positioning satellite (hereinafter referred to as “GPS”) receiver or otherwise be linked to an external source of GPS information. Some of the reasons for acquiring GPS information to monitor the position of an aircraft are:

a) before landing, the PANO can automatically park the heads of, and power down, its hard drives, as well as secure other shock sensitive equipment which may be prone to damage if it were operated during landing;

b) periodically reporting its position to the central controller may be useful in monitoring the overall operation and health of the network;

c) a service can be provided to passengers that allows them to view a map plotting their current position relative to scenic landmarks as they fly over them; and,

d) a service can be provided that could track the whereabouts of a passenger so business associates and/or loved ones could monitor when the passenger on a delayed flight was actually expected to land.

Practicing the Globally Distributed Network Comprising a Plurality of PANOs

Just as multiple objects in C++ interact and communicate with each other using messages, any PANO or every PANO in a globally distributed network populated by a plurality of PANOs, can be monitored and controlled by sending one or more messages from: a) a central control device, b) an auxiliary or backup control device, or c) another PANO. According to the practice of the instant invention, messages may be of any length and can be employed to perform a multitude of functions within the network. The reasons for sending message between PANOs and/or between PANOs and the central controller include, but are not limited to:

a) initiate or control the behavior of a PANO by launching an internal method call to initiate a specific action;

b) set the value of a property in a PANO to set parameters of its operating environment;

c) transmit a data file to be included in the redundant collections of multimedia information;

d) transmit a user-generated data file;

e) transmit elements of the user environment code;

f) transmit elements of a user's psychographic profile;

g) transmit e-commerce transaction information;

h) transmit equipment failure reports and maintenance requests; and,

i) transmit logs and status reports.

Messages may be actual or virtual. An example of an actual message (hereinafter referred to as “actual messaging”) is a message sent from the central controller to the PANO, or from one PANO to another PANO, containing the actual instruction for the PANO to report on the operational readiness of its internal nonvolatile storage devices or to report the present position of the aircraft. An example of a virtual message (hereinafter referred to as “virtual messaging”) is a message sent from the central controller to a PANO conveying a user environment preference code, or a user psychographic profile data element. Messages conveying user environment preference codes or user psychographic profile data elements do not necessarily convey the actual user preference code or psychographic profile data element. Virtual messaging uses messages containing pointers to the actual user preference code or psychographic profile data element that resides within the cells of one or more lookup tables contained in the programming of every PANO.

Lookup tables can be of any size, but in a preferred embodiment of the present invention a table matrix of 16 columns by 256 rows is utilized because it contains a practical number of data elements and can be accessed by use of a single hexadecimal character. A hexadecimal character contains two bytes (16 binary digits) if digital information. By splitting the hexadecimal character into its individual bytes, a first byte can be read bit-wise providing 16 “On” or “Off” conditions. A second byte can be read according to its binary numerical value of 0 to 256. Therefore a single hexadecimal character can used to access a table of 4096 cells, i.e. 16 columns with each column containing of 256 rows of cells. Each cell in such a lookup table can be used to store a single data element of any length. This means a simple two character word can convey all the information contained in a dataset of 4096 data elements. Moreover, each data element can consist of any type of data, including but not limited to, strings of textual information, numerical information, including mathematical formulae, internal pointers, and code blocks, among others.

Lookup tables can be any size. The lookup table referred to above was limited to a practical size of 4096 cells (16×256=4096). Actually a single hexadecimal character could also be used to access a table of 65,536 cells by using the numerical values of both bytes (256×256=65,536). The only requirement is that the one or more lookup tables be redundantly contained in every PANO and the central controller. Since most of the messages conveyed between PANOs and the central controller contain predictable and reusable data elements, transmitting pointers to information stored in the lookup tables can convey such information much more rapidly, and with far less consumption of WAN-bandwidth.

It is a primary objective of the present invention to conserve the use of WAN-bandwidth whenever and wherever possible. Conserving WAN-bandwidth not only makes the delivery of digital information to transient users less costly, it also makes the delivery of digital information to transient users more reliable. Since PANOs operate as closed-loop data processing systems in sheltered environments, the services are not as likely to be interrupted due to interference generated by events such as electrical storms, sun spots, and the like.

PANOs may be stationary or mobile. A PANO communicates with a central control device, an auxiliary control device, or another PANO by transmitting messages over a WAN. The circuit that serves as a carrier for transmitting such messages may be a cable or wireless telecommunications network, or any combination thereof. Messages may contain any type of digital information, such as machine control instructions or digital files of any type. All messages are received by, and transmitted to, the PANOs superobject. Messages are comprised of one or more packets of digital information which contain at least the following:

a) the IP address of the PANO to which the message is being sent;

b) the IP address of the PANO or central controller originating the message; and,

c) a quantity of digital information.

Messages may also be transmitted to, or received by, a PANO by means of using a software agent to convey such message.

Reference is made to FIG. 2 which shows a minimum of basic network components required to practice the most preferred embodiment of the present invention. To practice the present invention, at least one central controller (22) is connected by means of a fiber optic or copper cable to at least one terrestrial communications network (21), and to at least one earth-orbiting communications satellite (17). The terrestrial communications network (21) and the earth orbiting satellite (17) are connected to at least one WAN (18). A plurality of mobile PANOs (19) and a plurality of stationary PANOs (20) may communicate as needed with the central controller (22), a WAN (18), and each other (19) and (20) by means of the terrestrial communications network (21) and/or the earth-orbiting communications satellite (17).

As stated above, the PANO is the fundamental appliance for delivering digital services to globally distributed groups of transient users. Most of the services provided by the most preferred embodiment of the present invention are delivered to transient users from digital files locally stored in a nonvolatile manner within the confines of the closed-loop data processing system of the PANO. This is especially true of services requiring repetitive access to the PANO's inventory of commonly read read-only data files, such as new releases, business applications, and interactive games. Therefore, the quality of experience for each group of transient users is primarily defined by the scope of each PANO's hardware, programming and inventory. The delivery of services to groups of transient users takes place within the confines of the closed-loop data processing system of the PANO. This requires a minimum of reliance upon transmitting digital information via satellite or terrestrial communications network, i.e. WAN-transmitted data.

The main advantages of the closed-loop data processing system are, data security, bandwidth conservation, and economy. There is no preferred mode of transmission for the transfer of digital information between the basic network components of the present invention. Circumstances such as the cost and availability of WAN-bandwidth are the prime determinants. However, the economics and availability for transmission of digital information presently tend to favor the use of fiber optic cable networks, wherever possible, over that of satellite or other forms of wireless transmission.

Practicing the Services that Travel with You

PANOs provide transient users with “service zones” whose reach is defined by the total number of access portals attached to the PANO server by means of a cabled or wireless network interface.

Redundant collections of services, include but not limited to, business applications, entertainment and educational content selections, and e-commerce transaction services. These services are provided and facilitated within the service zones in such a manner that transient users can seamlessly move between individual service zones with little or no awareness they have moved from one service zone to another. This is possible because the hardware and software, as well as the basic user interface is consistent from PANO to PANO. This is conceptually similar to moving between reception zones in a cellular telephone system.

Thus, in one of its broadest embodiments, the invention provides a method and system which includes software that behaves substantially in the manner of a superobject; and, hardware that behaves in a substantially autonomous manner when manipulated by the software. In regard to this embodiment, the invention is broadly applicable to any system that includes software and hardware. Stated otherwise, the core of the invention is not merely limited to a system and method for providing services to a transient user. In an alternate broad embodiment the invention provides in a system, software for controlling a system, or the software and hardware, including at least one closed-loop data processing system for serving at least one transient user having an itinerary, of a plurality of globally distributed groups of transient users, with at least substantially all of the services that the at least one transient user would otherwise have available through a personal computer within the home of the at least one transient user and/or a business computer within the place of business of the at least one transient user at, at least one point on the itinerary of the at least one transient user other than the home and/or the place of business; and, a portion of the software causing the at least one-closed loop data processing system to behave in a substantially autonomous manner.

The scope of the broad system is further limited by the hardware that may include, but is not necessarily limited to: at least one closed-loop data processing system; at least one central control device, for at least controlling the at least one closed-loop data processing system; at least one database for nonvolatile storage of digital information; at least one data transmission device, for two-way transmission of the digital information; at least one wide area network; and, software that includes algorithms for: causing the at least one closed-loop data processing system to behave in a substantially autonomous manner; causing the at least one closed-loop data processing system to function as an audio and/or video presentation system; causing the at least one closed-loop data processing system to function as a digital rights management system; causing the at least one closed-loop data processing system to function as a user psychographic profile management system; causing the at least one closed-loop data processing system to function as an e-commerce transaction management system; causing the at least one closed-loop data processing system to function as a billing and tracking system; interfacing the at least one closed-loop data processing system with another the at least one the closed-loop data processing system; interfacing the at least one central control device with the at least one closed loop data processing system; interfacing the at least one central control device with the at least one database; interfacing the at least one central control device with the at least one data transmission device; and, interfacing the at least one data transmission device with the at least one wide area network.

The at least one closed-loop data processing system can be mobile or stationary. It may further include, but is not necessarily limited to: at least one computer network server; a software-based program that functions as a master control system; at least one nonvolatile mass storage device; at least one network router, switch and/or hub; and, at least one computer workstation. The at least one computer workstation, may include but is not necessarily limited to: a display device; a keyboard (or the like); a cursor pointing device (or the like); an audio headset; a network interface connector; and a card reader device (or the like).

The digital information further includes redundant collections of multimedia information. These redundant collections of multimedia information may include but are not necessarily limited to: feature movies, television programs, cartoons, still images, animated sequences of still images, digital audio files, digital video files, interactive games, advertisements, market research items, product catalogs, and/or promotional information describing the suitability and features of products and services.

The digital audio and/or video data files may include, but are not necessarily limited to: documentaries, instructional programs, correspondence courses, sporting events, and/or news and financial reporting services.

The advertisements, market research items, product catalogs and/or promotional information describing the suitability and features of products and services may or may not be targeted according to the demographic and/or psychographic profile of the at least one transient user.

The individual items of the redundant collections of multimedia information are grouped and offered to the at least one transient user in a manner that may or may not be targeted according to the demographic and/or psychographic profile of the at least one transient user.

The at least one point may be stationary or movable. It may be situated in a space port, an airport, a train station, a bus station, a taxi depot, a limo depot, a marine depot, a hotel, a motel, a resort and the like. Alternatively, the at least one point may be situated in a spacecraft, a space station, an aircraft, a train, a bus, an automobile, a taxi, a limousine, a marine craft, a submarine craft and the like.

The services may include, but are not necessarily limited to: storage and delivery of electronic information including audio and/or video entertainment and educational content; running business software applications; running interactive games; transacting e-commerce marketing activities; interacting with at least one wide area network; accessing redundant collections of multimedia information including still images, animated sequences of still images, interactive games, digital audio files and/or digital video files, including feature movies, television programs, cartoons, documentaries, instructional programs, correspondence courses, sporting events, news and financial reporting services, advertisements, market research items, product catalogs, and promotional information describing the suitability and features of products and services.

The accessing of the services may or may not be targeted to appeal to the at least one transient user according to the demographic and/or psychographic profile of the at least one transient user. It may be accomplished in such a manner that the at least one transient user can begin accessing a file containing an item of the digital information at, at least one point on the itinerary, halt the accessing of the file containing an item of the digital information, and resume accessing the file containing the item of the digital information from another at least one point on the itinerary. It may be done by means of unicasting at least one file containing an item of the digital information to an individual the at least one transient user. It may be done by means of simultaneously multicasting at least one file containing an item of the digital information to a plurality of the at least one transient user.

The at least one file containing an item of the digital information may be a signal of a live event, presented to the at least one transient user in real time. Alternatively it may be a signal of a recorded event presented to the at least one transient user upon a demand being generated by the at least one transient user.

In an alternate broad expression of the invention, a method is provided that includes: serving at least one transient user having an itinerary, of a plurality of globally distributed groups of transient users, with at least substantially all of the services that the at least one transient user would otherwise have available through a personal computer within the home of the at least one transient user and/or a business computer within the place of business of the at least one transient user at, at least one point on the itinerary other than the home and/or the place of business.

As in the case of system of the invention, the at least one point may be stationary or movable. It may be situated in a space port, an airport, a train station, a bus station, a taxi depot, a limo depot, a marine depot, a hotel, a motel, a resort, or the like. It may be situated in a spacecraft, a space station, an aircraft, a train, a bus, an automobile, a taxi, a limousine, a marine craft, a submarine craft or the like.

Similarly, the services of the method may include, but are not necessarily limited to: storage and delivery of electronic information including audio and/or video entertainment and educational content; running business software applications; running interactive games; transacting e-commerce marketing activities; and, interacting with at least one wide area network. The services may further include, but are not necessarily limited to: accessing redundant collections of multimedia information including still images, animated sequences of still images, interactive games, digital audio files and/or digital video files, including feature movies, television programs, cartoons, documentaries, instructional programs, correspondence courses, sporting events, news and financial reporting services, advertisements, market research items, product catalogs, and promotional information describing the suitability and features of products and services.

The accessing of the services may or may not be targeted to appeal to the at least one transient user according to the demographic and/or psychographic profile of the at least one transient user.

The accessing of the services may be accomplished in such a manner that the at least one transient user can begin accessing a file containing an item of the digital information at, at least one point on the itinerary, halt the accessing of the file containing an item of the digital information, and resume accessing the file containing the item of the digital information from another at least one point on the itinerary. It may done by means of unicasting at least one file containing an item of the digital information to an individual the at least one transient user. It may be done by means of simultaneously multicasting the at least one file containing an item of the digital information to a plurality of the at least one transient user, or the like.

As in the case of the system, the at least one file containing an item of the digital information may be a signal of a live event, presented to the at least one transient user in real time. Alternatively it may be a signal of a recorded event presented to the at least one transient user upon a demand being generated by the at least one transient user.

In a narrower sense the invention provides a system that includes, but is not necessarily limited to: software for controlling a system and hardware including at least one closed-loop data process system, for serving at least one transient user having an itinerary, of a plurality of globally distributed groups of transient users, with at least substantially all of the services that the at least one transient user would otherwise have available through a personal computer within the home of the at least one transient user and/or a business computer within the place of business of the at least one transient user at, at least one point on the itinerary other than the home and/or the place of business. The hardware of the system includes, but is not necessarily limited to: at least one closed-loop data processing system; at least one central control device for at least controlling at least one the closed-loop data processing system; at least one database for nonvolatile storage of digital information; at least one data transmission device; and, at least one wide area network. The software for the system includes but is not necessarily limited to, software for: causing the at least one closed-loop data processing system to behave in a substantially autonomous manner; causing the at least one closed-loop data processing system to function as a digital rights management system; causing the at least one closed-loop data processing system to function as a user psychographic profile management system; causing the at least one closed-loop data processing system to function as a billing and tracking system; interfacing the at least one closed-loop data processing system with another the at least one the closed-loop data processing system; interfacing the at least one central control device with the at least one closed loop data processing system; interfacing the at least one central control device with the at least one database; interfacing the at least one central control device with the at least one data transmission device; and, interfacing the at least one data transmission device with the at least one wide area network.

### EXAMPLES OF METHODS USED TO PRACTICE THE PRESENT INVENTION

The foregoing list is exemplary, and is by no means meant to limit the scope of the present invention. Therefore the invention may be further understood through the following examples:

### Example 1

A family of five living outside Chicago takes a vacation to Disneyland in Anaheim, Calif. Their flight to Los Angeles has a scheduled one-hour layover in Denver. As per instructions from the airline they arrived at the O'Hare Airport one hour before their scheduled departure, checked their luggage, and proceeded to the boarding area. In the boarding area they went to the digital lounge and all five sat down at five access portals (FIGS. 1-2) and began to practice the present invention.

Dad swiped his credit card through the attached card reader device (FIGS. 1-5), whereby the screen automatically activated and a login wizard appeared and asked for Dad's username and password. Since Dad had never used the service before he clicked the button named “New User” and was asked if he wanted to sign up for any of a variety of services. He declined all but the free entertainment features. He was then asked if he wanted to activate any more access portals. He entered the access portal position numbers for his wife and each of their children, along with the age and sex of everyone including himself. Whereupon each was presented with graphical menus wherein the selection criteria was psychographically profiled to everyone's age and sex. Each member of the family selected program choices according to their individual interests.

When they were called to board the plane, they all logged off and boarded the aircraft. Once onboard the aircraft, Dad logged on to the access portal located at his seat. The system recognized him and asked for the locations of Mom and the kids. Then the programming allowed them all to resume watching whatever they were watching in the waiting lounge or move on to something else. Their original selections remain bookmarked and ready to resume until each member of the family was finished watching their individual selections.

### Example 2

A business person needed to make a business trip. She had already pre-registered with a service provider practicing the instant invention. Before leaving on her trip, she called up a software program supplied by her service provider. She entered the name of her airline and flight number, along with the dates and times of departure at each point along her itinerary. Then she entered the filenames and locations of three unfinished letters she was composing to business acquaintances, an unfinished business plan, and an unfinished PowerPoint presentation. The files were then automatically transferred to the central controller (FIGS. 2-22).

She boarded the airplane for the first leg of her trip, and logged on at the access portal (FIGS. 2-19) attached to the back of the seat in front of her. The programming greeted her by name and announced that her letters and PowerPoint files were already downloaded to the free store and were waiting. She selected a letter from the list. The programming announced that the letter was written in MS Word2000 and asked if she would like to continue the letter in Word2000, or would she like to try out a different word processor such as the latest release of Word Perfect or Word2002 XP. This choice was possible since the PANO possessed several word processors to choose from. She decides to try XP and finished the first letter. This is a great piece of software she thought, and clicked on the button to purchase it. Since her personal information and credit card information were already resident, the programming completed the e-commerce transaction by asking her to confirm her shipping address. She entered the shipping address of her office. The PANO then sent the e-commerce transaction information to the central controller (FIGS. 2-22). In response to the transaction information, the service provider then shipped the software purchase the same day. Her new software purchase was waiting on her desk in her office when she returned from her business trip the next day.

When she landed the flight maintenance crew attached a fiber optic link to the plane and her files were automatically forwarded to the local airport PANO (FIGS. 2-20), and copied to the central controller (FIGS. 2-22) as a backup. Her flight had a one-hour layover and change of planes in Atlanta. After deplaning her first flight, she went to the digital lounge in the waiting area and logged on to the local airport PANO (FIGS. 2-20). Since her files were already transferred to the local airport PANO she was ready to continue her work.

A half hour before her flight, the programming of the local airport PANO sent her a popup screen announcing that the aircraft scheduled to carry her to her final destination had just arrived. It also informed her that as soon as she logged off the access portal where she was presently working, that her files would be automatically forwarded to the next PANO designated on her itinerary.

That evening, after concluding her business meetings and having dinner, she logged onto the PANO located in her hotel room (FIGS. 2-20). She worked awhile on her PowerPoint presentation and decided to call it a night by renting a newly released feature movie. She only watched about a half-hour of the movie before she became too tired to continue. She stopped the movie and finished watched the remaining footage after she logged onto the airline PANO during her return flight home.

By practicing the present invention the business traveler was able to use a variety of software options and perform a plurality of business, e-commerce and entertainment functions that appeared to travel with her. This was all done without her need to carry a personal laptop or handheld computer.

Definitions

The term “access portal” as used herein refers to a terminal connected to a PANO server via a cable or wireless network interface device comprising at least one each of a: a) display device, b) keyboard (or the like), c) cursor pointing device (or the like), and d) such circuitry as is necessary for a transient user to gain 2-way access to available digital information.

The term “algorithm” as used herein refers to a predetermined set of computer instructions for performing a specific task and/or solving a specific problem using a limited number of steps.

The term “argument” as used herein refers to a data element or value which is passed to a method or stored in a property.

The term “autonomous” as used herein refers to a closed-loop data processing system's ability to perform its manifold functions in isolation with minimal outside support and/or control exerted by human agencies. It is the quality that the “superobject” enables.

The term “billing and tracking” as used herein refers to algorithms and software that collects, accumulates and aggregates a wide variety of charges accrued by a transient user in the course of using the services made possible by practicing the present invention.

The term “bit rate” as used herein refers to number of binary digits per second that flow within a bit stream.

The term “bit stream” as used herein refers to a continuous flow of binary digits.

The term “click-through” as used herein refers to the action of a computer user wherein the computer user uses a pointing device to select a menu item or icon, and by clicking on the menu item or icon to direct a browser to another page or data set.

The term “code block” as used herein refers to a short sequence of program code that is stored in a lookup table as textual instructions to be compiled “on-the-fly” by an inline compiler of the superobject and then executed, or that is stored as binary information in a lookup table for direct evaluation and execution by the superobject.

The term “content” as used herein refers to multimedia information in any digital form, including but not limited to information such as, music, still images, movies, multimedia presentations and advertisements, and the like.

The term “digital rights management” as used herein refers to algorithms and software that protects the digital rights of content owners which includes but is not limited to providing data encryption/decryption schemes, content usage tracking, and the like.

The term “expert system” refers to a rule-based software program designed to mimic the reasoning of a human specialist. Decisions reached by expert systems are commonly based upon rules that model principals of interpretation, representation, inference and uncertainty management.

The term “free store” as used herein refers to a quantity of nonvolatile mass storage dedicated to holding data files that are generated by, or for, a transient user. User-generated data files reside within a PANO for only such duration as the transient user is present in the PANO.

The term “Gbps” as used herein means gigabits per second, which is a bit rate of one billion bits per second.

An “interface” as used herein can exist in cyberspace, the real particle world, or the combination of both.

The term “internal pointer” as used herein describes a vector for locating an individual element of data in the cell of a lookup table.

The term “Kbps” as used herein means kilobits per second, which is a bit rate of one thousand bits per second.

The terms “large-scale software application” and “large-scale application” as used herein refers to an executable software program comprised of a plurality of functions that perform various specialized repetitive tasks within the confines overall application.

The term “last mile” as used herein means the final link, whether cable or wireless, that connects an Internet service provider with the home or office computer of a resident user.

The term “Mbps” as used herein means megabits per second, which is a bit rate of one million bits per second.

The term “message(s)” as used herein means a communication of digital information, such as commands and arguments to set or modify the behavior of a PANO, digital information files for storage or retrieval by transient users, and/or any other form of digital information, which might be transmitted between the central controller to one or more PANOs, from an auxiliary or backup controller to one or more PANOs, and/or from PANO to PANO.

The terms “multicast,” “broadcast,” and “point-to-multipoint” as used herein means a method of propagating information throughout a globally distributed network by means of transmitting it from a single network server to a multitude of remote network servers or network clients.

The term “multimedia” as used herein includes but is not limited to: digitized video, pictures and sounds, and the like, whether they appear to be moving or still.

The term “new releases” as used herein refers to episodic content, such as feature movies, that were released for public viewing within one year of the date the new releases were actually viewed by a transient user.

The term “nonvolatile” as used herein refers to any form of memory that continues to retain stored data after the supply of electrical power is disconnected.

The term “nexus” as used herein refers to a connection or link between individuals of a group.

The term “online” as used herein refers to a state of being connected to a WAN, such as the Internet or an ATM feeder network. An ATM feeder network is distinguishable from the Internet in that the Internet is a type of WAN available for public access, whereas an ATM feeder network is a specialized private WAN wherein the access and asynchronous transfer of data are restricted to only those entities practicing the present invention.

The term “optical link” as used herein refers to the transfer of digital information between two or more entities by means of a fiber optic cable.

The term “pipe” as used herein refers to either or both of a wireless circuit such as an antenna and/or satellite or other wireless transmission device, and/or a wire-based device such a fiber optic cable, copper cable, or the like.

The term “Point of Presence” as used herein refers to a network server that provides Internet access to the users it serves.

The terms “point-to-multipoint” and “multicast” are substantially interchangeable, as used herein.

The term “point-to-point” and “unicast” are substantially interchangeable, as used herein.

The term “psychographic profile management” as used herein refers to software that collects, accumulates and aggregates a wide variety of user preferences, including but not limited to those proffered by the user and those gleaned by observing a transient user's movements and responses within his/her computing environment for the purpose of developing, refining and maintaining a psychographic profile of the transient user's preferences. Tracking the transient user's movements and responses, includes but is not limited to observing the transient user's content selections, click-throughs, and/or e-commerce transactions, as well as evaluating answers to specific queries designed to develop, refine and maintain the transient user's psychographic profile.

The term “redundant collections of multimedia information” as used herein refers to a grouping or collection of read-only data files stored redundantly across all PANOs for access by all transient users.

The term “resident users” as used herein refers to computer users who access content delivered to computer systems located in their homes and/or places of business.

The term “robust” as used herein refers to the strength of having extensive features giving a software program the ability to reliably perform a wide variety of work.

The term “services” as used herein refers to that which transient users would otherwise have available to them through their own PC's (“personal computers”) within their homes and/or their business computers within their places of business; including but not limited to: a) the storage and delivery of electronic information such as audio and/or video entertainment and educational content; b) the running of business software applications and interactive games; c) the transacting of e-commerce marketing activities; and, d) the capacity to interactively link to a WAN for real-time 2-way transfer of digital information, and the like.

The term “serving” as used herein means “providing services.”

The term “service zone” as used herein describes an area or location occupied by a PANO for the purpose of delivering services. The outer boundary of the PANO is delineated by the total aggregate reach of its combined access portals.

The term “software agent” as used herein refers to a small computer program that performs some information gathering or processing task in the background to which one can delegate tasks. Software agents differ from conventional software in that they are long-lived, semi-autonomous, proactive, and adaptive. Typically, a software agent is assigned a very small and well-defined task.

The term “superobject” as used herein describes a master control system which is a semi-intelligent object oriented software program that is the highest software authority of a closed-loop data processing system, i.e. PANO. The superobject presides over a collection of automation utilities, hardware drivers, software applications, and data sets, and the like. Like an object in object oriented programming, the superobject contains “methods” that control various aspects of the PANO's behavior and “properties” that function like variables to store a plurality of data of various types.

The term “store-and-forward methods” as used herein refers to the technique of transmitting a multimedia data file, such as a movie, from one nonvolatile storage medium to another nonvolatile storage medium using a file transfer protocol such as “file transfer protocol” (herein referred to as “FTP”), and then streaming the contents of the multimedia data file directly to a display viewer.

The term “targeted” as used herein refers to the capacity to select a specific advertisement or content selection from a plurality of all available advertisements or content selections so that only those advertisements or content selections that are likely to appeal to a particular viewer are shown.

The term “terse” as used herein refers to short compact segments of computer code.

The term “transient users” as used herein refers to computer users who access content delivered to them while traveling and/or while being temporarily lodged away from their homes and/or places of business.

The terms “traveler,” “passenger” and “transient user” are substantially interchangeable, as used herein.

The terms “unicast” and “point-to-point” as used herein means a method of propagating information throughout a globally distributed network by means of transmitting it from a single network server to a single remote network server or network client.

The term “user input device” as used herein, includes but is not necessarily a keyboard, a voice controlled typing device, and the like.

The term “users” and “viewers” refer to people who use personal computers for any purpose whatsoever and are substantially interchangeable, as used herein.

The terms “video streaming” and “streaming” as used herein refers to a technique for transferring data in such a manner that it can be processed as a steady and substantially continuous bit stream that can start displaying the data before an entire multimedia file has been transmitted. The term “video streaming” and “streaming” are substantially interchangeable, as used herein.

The term “virtual computing environment” as used herein, refers to any geographic point on the itinerary of a traveler whereby such a traveler has access to the access portal of a PANO.

The terms “WAN” and “wide area network” as used herein refers to any public or private network that covers an area larger than a single building or campus, including the Internet.

The term “WAN-bandwidth” as used herein refers to terrestrial and satellite bandwidth consumed as a result of transmitting digital information over a WAN from any point to any other point.

The term “wireless link” as used herein refers to the transfer of digital information between two or more entities by means of converting such digital information into an electromagnetic waveform such as a radio wave, microwave, and the like, or by propagating lased or infrared light through the atmosphere, and the like.

The language “In a system . . . ” as used herein is intended to broadly embrace any of the individual elements and/or any combination of individual elements of the system including the entire system.

Although the invention has been described with reference to certain preferred embodiments, it will be appreciated that many variations and modifications may be made within the scope of the broad principles of the invention. Hence, it is intended that the preferred embodiments and all of such variations and modifications be included within the scope and spirit of the invention, as defined by the following claims.

I claim:

1. In a system comprising:
a) a first portion of software for causing at least one-closed loop data processing system within a system to behave in a substantially autonomous manner; and,
b) a second portion of said software for controlling all other functions of said system or, said software and hardware including said at least one closed-loop data processing system for serving at least one transient user having an itinerary, with at least substantially all of said services that said at least one transient user would otherwise have available through a personal computer within the home of said at least one transient user or a business computer within the place of business of said at least one transient user at, at least one point on said itinerary other than said home or said place of business.

2. The system of claim 1, wherein said hardware comprises any one or any combination of:
a) at least one closed-loop data processing system;
b) at least one central control device, for at least controlling at least one said closed-loop data processing system;
c) at least one database for nonvolatile storage of digital information;
d) at least one data transmission device; and,
e) at least one wide area network.

3. The system of claim 2, wherein said software comprises algorithms for:
a) causing said at least one closed-loop data processing system to behave in a substantially autonomous manner;
b) causing said at least one closed-loop data processing system to function as an audio presentation system, a video presentation system, and combinations thereof;
c) causing said at least one closed-loop data processing system to function as a digital rights management system;
d) causing said at least one closed-loop data processing system to function as a user psychographic profile management system;
e) causing said at least one closed-loop data processing system to function as an e-commerce management system;
f) causing said at least one closed-loop data processing system to function as a billing and tracking management system;
g) interfacing said at least one closed-loop data processing system with another said at least one said closed-loop data processing system;
h) interfacing said at least one central control device with said at least one closed loop data processing system;
i) interfacing said at least one central control device with said at least one database;
j) interfacing said at least one central control device with said at least one data transmission device; and,
k) interfacing said at least one data transmission device with said at least one wide area network.

4. The system of claim 2, wherein said at least one closed-loop data processing system further comprises:
a) at least one computer network server;
b) a software-based program that functions as a master control system;
c) at least one nonvolatile mass storage device;
d) at least one network router, network switch, network hub, and combinations thereof; and,
e) at least one computer workstation.

5. The system of claim 4, wherein said at least one computer workstation, of said at least one closed-loop data processing system, further comprises:
a) a display device;
b) a user input device;
c) a cursor pointing device, and;
d) an audio headset;

6. The system of claim 5, wherein said at least one computer workstation, of said at least one closed-loop data processing system, further comprises a network interface connector.

7. The system of claim 5, wherein said at least one computer workstation, of said at least one closed-loop data processing system, further comprises a card reader device.

8. The system of claim 2, wherein said at least one closed-loop data processing system is mobile.

9. The system of claim 2, wherein said at least one closed-loop data processing system is stationary.

10. The system of claim 2, wherein said digital information included redundant collections of multimedia information.

11. The system of claim 10, wherein said redundant collections of multimedia information comprises: feature movies, television programs, cartoons, still images, animated sequences of still images, digital audio files, digital video files, interactive games and combinations thereof.

12. The system of claim 11, wherein said digital audio and data files, digital video data files comprise documentaries, instructional programs, correspondence courses, sporting events, news and financial reporting services, and combinations thereof.

13. The system of claim 10, wherein said redundant collections of multimedia information comprise advertisements, market research items, product catalogs, promotional information describing the suitability and features of products and services, and combinations thereof.

14. The system of claim 13, wherein said advertisements, market research items, product catalogs, promotional information describing the suitability and features of products and services, and combinations thereof, are not targeted according to the demographic and psychographic profiles of said at least one transient user.

15. The system of claim 13, wherein said advertisements, market research items, product catalogs, promotional information describing the suitability and features of products and services, and combinations thereof, are specifically targeted to appeal to said at least one transient user according to the demographic and psychographic profiles of said at least one transient user.

16. The system of claim 10, wherein individual items of said redundant collections of multimedia information are grouped and offered to said at least one transient user in a manner that is not targeted according to the demographic or psychographic profiles of said at least one transient user.

17. The system of claim 10, wherein individual items of said redundant collections of multimedia information are grouped and offered to said at least one transient user in a manner that is targeted to appeal to said at least one transient user according to the demographic or psychographic profiles of said at least one transient user.

18. A method comprising:
serving at least one transient user having an itinerary, of a plurality of globally distributed groups of transient users, with at least substantially all of the services that said at least one transient user would otherwise have available through a personal computer within the home of said at least one transient user or a business computer within the place of business of said at least one transient user at, at least one point on said itinerary other than said home or said place of business.

19. The method of claim 18, wherein said at least one point is stationary.

20. The method of claim 18, wherein said at least one point is movable.

21. The method of claim 19, wherein said at least one point is situated in a space port, an airport, a train station, a bus station, a taxi depot, a limo depot, a marine depot, a hotel, a motel, or a resort.

22. The method of claim 20, wherein said at least one point is situated in a spacecraft, a space station, an aircraft, a train, a bus, an automobile, a taxi, a limousine, a marine craft or a submarine craft.

23. The method of claim 18, wherein said services comprise:
a) storage and delivery of electronic information including audio entertainment, video entertainment, educational content, and combinations thereof;
b) running business software applications;
c) running interactive games;
d) transacting e-commerce marketing activities; and,
e) interacting with at least one wide area network.

24. The method of claim 23, wherein said services comprise: accessing redundant collections of multimedia information including still images, animated sequences of still images, interactive games, digital audio files, digital video files, and combinations thereof, including feature movies, television programs, cartoons, documentaries, instructional programs, correspondence courses, sporting events, news and financial reporting services, advertisements, market research items, product catalogs, and promotional information describing the suitability and features of products and services, and combinations thereof.

25. The method of claim 24, wherein said accessing of said services is not targeted to appeal to said at least one transient user according to the demographic or psychographic profile of said at least one transient user.

26. The method of claim 24, wherein said accessing of said services is targeted to appeal to said at least one transient user according to the demographic and psychographic profiles of said at least one transient user.

27. The method of claim 24, wherein said accessing of said services may be accomplished in such a manner that said at least one transient user can begin accessing a file containing an item of said digital information at, at least one point on said itinerary, halt said accessing of said file containing an item of said digital information, and resume accessing said file containing said item of said digital information from another at least one point on said itinerary.

28. The method of claim 24, wherein said accessing of said redundant collections of multimedia information is done by means of unicasting at least one file containing an item of said digital information to an individual said at least one transient user.

29. The method of claim 24, wherein said accessing of said redundant collections of multimedia information is done by means of simultaneously multicasting at least one file containing an item of said digital information to a plurality of said at least one transient user.

30. The method of claims 24, wherein said at least one file containing an item of said digital information is a signal of a live event, presented to said at least one transient user in real time.

31. The method of claims 24, wherein said at least one file containing an item of said digital information is a signal of a recorded event presented to said at least one transient user upon a demand being generated by said at least one transient user.

32. A system comprising:
software and hardware including at least one closed-loop data process system, for serving at least one transient user having an itinerary, of a plurality of globally distributed groups of transient users, with at least substantially all of the services that said at least one transient user would otherwise have available through a personal computer within the home of said at least one transient user or a business computer within the place of business of said at least one transient user at, at least one point on said itinerary other than said home or said place of business;
wherein said hardware comprises:
a) at least one closed-loop data processing system;
b) at least one central control device for at least controlling at least one said closed-loop data processing system;
c) at least one database for nonvolatile storage of digital information;
d) at least one data transmission device; and,
e) at least one wide area network; and,
wherein said software comprises, software for:
i) causing said at least one closed-loop data processing system to behave in a substantially autonomous manner;
ii) causing said at least one closed-loop data processing system to function as a digital rights management system;
iii) causing said at least one closed-loop data processing system to function as a user psychographic profile management system;
iv) causing said at least one closed-loop data processing system to function as an e-commerce management system;
v) causing said at least one closed-loop data processing system to function as a billing and tracking system;
vi) interfacing said at least one closed-loop data processing system with another said at least one said closed-loop data processing system;
vii) interfacing said at least one central control device with said at least one closed loop data processing system;
viii) interfacing said at least one central control device with said at least one database;
ix) interfacing said at least one central control device with said at least one data transmission device; and,
x) interfacing said at least one data transmission device with said at least one wide area network.

32. A software system comprising:
a) a first portion of software for enabling at least one-closed loop data processing system within a system to behave in a substantially autonomous manner; and,
b) a second portion of said software for controlling all other functions of said system including said at least one closed-loop data processing system for serving at least one transient user, having an itinerary, with at least substantially all of the services that said at least one transient user would otherwise have available through a personal computer within the home of said at least one transient user or a business computer within the place of business of said at least one transient user at, at least one point on said itinerary other than said home or said place of business.

33. A system comprising:
a) software for behaving substantially in the manner of a superobject; and,
b) hardware which is caused by said software to behave in a substantially autonomous manner.

34. A system for providing access through a wide area network to globally distributed redundant collections of multimedia information by at least one transient user of a plurality of globally distributed groups of transient users, comprising:
a) at least one closed-loop data processing system further comprising all hardware and software as are necessary for said at least one closed-loop data processing system to function in a substantially autonomous manner;
b) at least one central control device for synchronizing and controlling the operations of a plurality of said at least one closed-loop data processing system;
c) at least one database further comprising at least one nonvolatile storage device for archival storage of said redundant collections of multimedia information;
d) at least one transmission device for transmitting digital information by means of said wide area network;
e) at least one first link for linking said central control device to said at least one at least one database;
f) at least one second link for linking said central control device to said at least one transmission device;
g) at least one wireless link for linking said at least one closed-loop data processing system to another at least one closed-loop data processing system or to said central control device;
h) at least one cable or optical link for linking said at least one closed-loop data processing system to another at least one closed-loop data processing system and to said central control device;
i) software for linking said at least one closed-loop data processing system to another at least one closed-loop data processing system and to said central control device;
j) software for linking at least one closed-loop data processing system to said at least one data transmission device;
k) software for linking said at least one data transmission device to a wide area network;

35. The system of claim 34, wherein said at least one closed-loop data processing system is mobile.

36. The system of claim 34, wherein said at least one closed-loop data processing system is stationary.

37. The system of claim 34, wherein said redundant collections of multimedia information is comprised of still images, animated sequences of still images, digital audio files, digital video files, user-generated data files, and user preference codes.

38. The system of claim 37, wherein said digital audio data files, digital video data files, and combinations thereof, include but are not limited to feature movies, television programs, cartoons, news and financial reporting, sporting events, educational programs, documentaries, instructional programs, as well as advertising messages and promotional information describing the suitability and features of products and services.

39. The system of claim 38, wherein said advertising messages and promotional information describing the suitability and features of products and services are not targeted according to the demographic and psychographic profiles of said at least one transient user.

40. The system of claim 38, wherein said advertising messages and promotional information describing the suitability and features of products and services are specifically targeted to appeal to said at least one transient user according to the demographic and psychographic profile of said at least one transient user.

41. A method comprising:
a) providing software for behaving substantially in the manner of a superobject; and,
b) causing hardware to behave in a substantially autonomous manner by said software.
